(19) United States
(12) Patent Application Publication
(10) Pub. No.: US 2022/0004198 A1
(43) Pub. Date: Jan. 6, 2022

(54) ELECTRONIC DEVICE AND CONTROL METHOD THEREFOR

(71) Applicant: Samsung Electronics Co., Ltd., Suwon-si, Gyeonggi-do (KR)

(72) Inventors: Minwoo RYU, Suwon-si (KR); Donghun LEE, Suwon-si (KR); Hyoungwoo LIM, Seongnam-si (KR); Changho HA, Suwon-si (KR)

(21) Appl. No.: 17/290,886

(22) PCT Filed: Feb. 20, 2020
(86) PCT No.: PCT/KR2020/002487

§ 371 Date: May 3, 2021

(30) Foreign Application Priority Data
Apr. 5, 2019 (KR) 10-2019-0040407

(51) Int. Cl. G05D 1/02

(52) U.S. Cl. CPC G05D 1/0251; G05D 1/024; G05D 1/0274

(57) ABSTRACT

An electronic device and a control method therefor are disclosed. The control method for the electronic device according to the present disclosure comprises the steps of acquiring a plurality of pieces of 3D data on the basis of sensing information detected through a 3D sensor while the electronic device is driving, determining, by using the acquired plurality of pieces of 3D data, at least one height section for an object existing in the direction in which the electronic device is driving, from among a plurality of preset height sections, and controlling the driving of the electronic device on the basis of the determined height section for the object.

### TECHNICAL FIELD

The disclosure is to provide an electronic device and a control method therefore, and more particularly to, an electronic device autonomously running by recognizing objects based on data detected trough a 3D sensor and a control method therefor.

### BACKGROUND ART

An electronic device such as a robot cleaner cleans a room while autonomously running based on a predetermined running algorithm

Such an electronic device may recognize whether an obstacle is present in a direction in which the electronic device runs through a sensor provided in the electronic device, while autonomously running based on the predetermined running algorithm, to run by avoiding or climbing the corresponding obstacle.

Meanwhile, in the related art, an IR sensor or an ultrasonic sensor was used to detect whether an obstacle is present in a direction in which the electronic device runs.

However, a sensing region detected through the IR sensor or the ultrasonic sensor is extremely limited, and the number of pieces of data detected through the sensor corresponds to the number of sensors.

Accordingly, in order to recognize the obstacles around the electronic device, a plurality of sensors needed to be attached to the electronic device.

In order to improve the above problem, in recent years, a 3D sensor is mounted on the electronic device to detect an obstacle located in a running direction of the electronic device.

### DISCLOSURE

### Technical Problem

In such a 3D sensor method, the number of pieces of data corresponding to the number of image pixels (VGA level or higher) are sensed, and accordingly, the plurality of sensors such as the IR sensor or the ultrasonic sensor do not need to be provided in the electronic device. However, as descried above, since, in the 3D sensor method, the number of pieces of data corresponding to the number of image pixels (VGA level or higher) are sensed, a large amount of sensed data needed to be processed on the electronic device.

### Technical Solution

The disclosure is made to solve the above problems and an object of the disclosure is to allow an electronic device such as a robot cleaner to optimize a plurality of pieces of data obtained through a 3D sensor.

Another object of the disclosure is to allow the electronic device to perform autonomous running using a voxel map generated by using the optimized data.

In accordance with an aspect for achieving the above objects, there is provided a method for controlling an electronic device, the method including obtaining a plurality of pieces of 3D data based on sensing information detected through a 3D sensor while the electronic device runs, determining at least one height section of an object present in a direction in which the electronic device runs among a plurality of predetermined height sections by using the plurality of pieces of obtained 3D data, and controlling running of the electronic device based on the determined height section of the object.

The determining may include classifying the plurality of pieces of 3D data into at least one group based on the plurality of height sections, and generating voxels corresponding to the classified groups, respectively, and generating a voxel map including the generated voxels.

The determining may further include determining a height section of each of the plurality of voxels based on a representative value set for each of the plurality of voxels included in the voxel map.

The generating the voxel map may include generating a section including the pieces of 3D data equal to or more than a predetermined threshold number among the plurality of height sections as a voxel.

The generating the voxel map may include not generating a voxel by processing a section including the pieces of 3D data equal to or less than a predetermined threshold number among the plurality of height sections as noise.

The plurality of height sections may include at least one of a first section for determining that an object is not an obstacle, a second section for determining whether it is able to pass by the object, a third section for avoiding the object, a fourth section in which it is able to pass by a part of the object, and a fifth section in which it is able to pass by the entire object.

The controlling may include, based on a representative value of at least one voxel among the plurality of voxels being determined to be related to the first section, perform control so that the electronic device runs forward, and based on a representative value of at least one voxel among the plurality of voxels being determined to be related to the remaining sections excluding the first section, perform control so that the electronic device avoids the object.

The controlling may include, based on a height of the object being determined in a threshold height section or lower among the plurality of height sections, obtaining information on the object based on the 3D data, and after the running around the object is completed, performing control to start running with respect to the object based on the information on the object.

The 3D sensor may be a 3D light detection and ranging (LIDAR) sensor.

In accordance with another aspect of the disclosure, there is provided an electronic device including a 3D sensor, and a processor configured to, based on a plurality of pieces of 3D data being obtained through the 3D sensor while the electronic device runs, determine at least one height section of an object present in a direction in which the electronic device runs among a plurality of predetermined height sections by using the plurality of pieces of obtained 3D data, and control running of the electronic device based on the determined height section of the object.

The processor may be configured to classify the plurality of pieces of 3D data into at least one group based on the plurality of height sections, generate voxels corresponding to the classified groups, respectively, and generate a voxel map including the generated voxels.

The processor may be configured to determine a height section of each of the plurality of voxels based on a representative value set for each of the plurality of voxels included in the voxel map.

The processor may be configured to generate a section including the pieces of 3D data equal to or more than a predetermined threshold number among the plurality of height sections as a voxel.

The processor may be configured to not generate a voxel by processing a section including the pieces of 3D data equal to or less than a predetermined threshold number among the plurality of height sections as noise.

The plurality of height sections may include at least one of a first section for determining that an object is not an obstacle, a second section for determining whether it is able to pass by the object, a third section for avoiding the object, a fourth section in which it is able to pass by a part of the object, and a fifth section in which it is able to pass by the entire object.

The processor may be configured to, based on a representative value of at least one voxel among the plurality of voxels being determined to be related to the first section, perform control so that the electronic device runs forward, and based on a representative value of at least one voxel among the plurality of voxels being determined to be related to the remaining sections excluding the first section, perform control so that the electronic device avoids the object.

The device may further include a storage storing information on at least one object, and the processor may be configured to, based on a height of the object being determined in a threshold height section or lower among the plurality of height sections, obtain information on the object from the storage based on the 3D data, and after the running around the object is completed, perform control to start running with respect to the object based on the information on the object.

The 3D sensor may be a 3D light detection and ranging (LIDAR) sensor.

Effect of Invention

As described above, according to the disclosure, the electronic device such as a robot cleaner may optimize the plurality of pieces of data obtained through the 3D sensor and perform the autonomous running by using the voxel map generated by using the optimized data.

### DESCRIPTION OF DRAWINGS

FIG. 1 is a block diagram of an electronic device according to an embodiment;

FIG. 2 is a specific block diagram of the electronic device according to an embodiment;

FIG. 3 is a specific block diagram of a processor according to an embodiment;

FIG. 4 is a diagram of an example in which a voxel map is generated according to an embodiment;

FIG. 5 is a diagram of an example in which a voxel map is determined on the electronic device according to an embodiment;

FIG. 6 is a diagram of an example in which it is determined whether to run by an object on the electronic device according to an embodiment;

FIG. 7 is a flowchart of a method for controlling the electronic device according to an embodiment; and

FIG. 8 is a flowchart of a method for determining a height section of an object present in a running direction of the electronic device by using a plurality of pieces of 3D data on the electronic device according to an embodiment.

### BEST MODE

### DETAILED DESCRIPTION OF EXEMPLARY EMBODIMENTS

Hereinafter, various embodiments of the disclosure will be described with reference to the accompanying drawings. It should be noted that the technologies disclosed in this disclosure are not for limiting the scope of the disclosure to a specific embodiment, but they should be interpreted to include all modifications, equivalents and/or alternatives of the embodiments of the disclosure. In relation to explanation of the drawings, similar reference numerals may be used for similar elements.

In this disclosure, the terms such as “comprise”, “may comprise”, “consist of”, or “may consist of” are used herein to designate a presence of corresponding features (e.g., constituent elements such as number, function, operation, or part), and not to preclude a presence of additional features.

In this disclosure, expressions such as “A or B”, “at least one of A [and/or] B,”, or “one or more of A [and/or] B,” include all possible combinations of the listed items. For example, “A or B”, “at least one of A and B,”, or “at least one of A or B” includes any of (1) at least one A, (2) at least one B, or (3) at least one A and at least one B.

The expressions “first,” “second” and the like used in the disclosure may denote various elements, regardless of order and/or importance, and may be used to distinguish one element from another, and does not limit the elements.

If it is described that a certain element (e.g., first element) is “operatively or communicatively coupled with/to” or is “connected to” another element (e.g., second element), it should be understood that the certain element may be connected to the other element directly or through still another element (e.g., third element). On the other hand, if it is described that a certain element (e.g., first element) is “directly coupled to” or “directly connected to” another element (e.g., second element), it may be understood that there is no element (e.g., third element) between the certain element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the expression “configured to” does not necessarily refer to a device being “specifically designed to” in terms of hardware. Instead, under some circumstances, the expression “a device configured to” may refer to the device being “capable of” performing an operation together with another device or component. For example, the phrase “a unit or a processor configured (or set) to perform A, B, and C” may refer, for example, and without limitation, to a dedicated processor (e.g., an embedded processor) for performing the corresponding operations, a generic-purpose processor (e.g., a central processing unit (CPU) or an application processor), or the like, that can perform the corresponding operations by executing one or more software programs stored in a memory device.

An electronic device according to various embodiments of the disclosure may include at least one of, for example, a smailphone, a tablet personal computer (PC), a mobile phone, a video phone, an e-book reader, a desktop personal computer (PC), a laptop personal computer (PC), a netbook computer, a workstation, a server, a personal digital assistant (PDA), a portable multimedia player (PMP), an MP3 player, a mobile medical device, a camera, a wearable device, or the like. According to various embodiments, a wearable device may include at least one of an accessory type (e.g., a watch, a ring, a bracelet, an ankle bracelet, a necklace, a pair of glasses, a contact lens or a head-mounted-device (HMD)); a fabric or a garment-embedded type (e.g.: electronic cloth); skin-attached type (e.g., a skin pad or a tattoo); or a bio-implant type (implantable circuit). In addition, in some embodiments, the electronic device may include at least one of, for example, a television, a digital video disk (DVD) player, an audio system, a refrigerator, air-conditioner, a vacuum cleaner, an oven, a microwave, a washing machine, an air purifier, a set top box, a home automation control panel, a security control panel, a media box (e.g., SAMSUNG HOMESYNC™, APPLE TV™, or GOOGLE TV™), a game console (e.g., XBOX™, PLAYSTATION™), an electronic dictionary, an electronic key, a camcorder, an electronic frame, or the like.

In other embodiments, the electronic device may include at least one of a variety of medical devices (e.g., various portable medical measurement devices such as a blood glucose meter, a heart rate meter, a blood pressure meter, or a temperature measuring device, magnetic resonance angiography (MRA), magnetic resonance imaging (MRI), or computed tomography (CT) scanner, or ultrasonic wave device, etc.), a navigation system, a global navigation satellite system (GNSS), an event data recorder (EDR), a flight data recorder (FDR), an automotive infotainment device, a marine electronic equipment (e.g., marine navigation devices, gyro compasses, etc.), avionics, a security device, a car head unit, industrial or domestic robots, a drone, an ATM of financial institution, a point of sale of (POS) a store, or an Internet of Things (IoT) device (e.g., light bulbs, sensors, sprinkler devices, fire alarms, thermostats, street lights, toasters, exercise equipment, hot water tanks, heater, boiler, etc.).

In this disclosure, a term “user” may refer to a person using an electronic device or a device using an electronic device (e.g., an artificial intelligence electronic device).

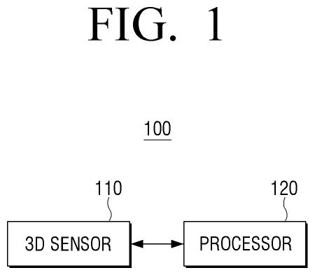

FIG. 1 is a block diagram of an electronic device according to an embodiment.

Referring to FIG. 1, an electronic device 100 may be, as a device capable of autonomous running, particularly a robot cleaner which sets a path by grasping surrounding features and cleans the surrounding area by autonomously running through the set path.

The electronic device 100 may include a 3D sensor 110 and a processor 120.

The 3D sensor 110 is a sensor configured to obtain a plurality of pieces of 3D data by detecting a surrounding environment in a direction of running while the electronic device 100 runs.

According to an embodiment, the 3D sensor 110 may be a 3D Lidar sensor.

The 3D Lidar sensor is a sensor configured to recognize the surrounding environment three-dimensionally to allow the electronic device 100 such as a vehicle or a robot cleaner to autonomously run safely, and the 3D Lidar sensor may measure a distance by continuously emitting several millions of laser beams per second and measuring a period of time taken for the several millions of the emitted laser beams being reflected and returning to the 3D Lidar sensor.

When a plurality of pieces of 3D data of the surrounding environment detected through the 3D sensor are obtained, the processor 120 may determine at least one height section of an object present in a direction in which the electronic device 100 runs among a plurality of predetermined height sections by using the plurality of pieces of obtained 3D data.

The processor 120 may control the running of the electronic device 100 based on the determined height section of the object.

Specifically, the processor 120 may classify the plurality of pieces of obtained 3D data into at least one group based on the plurality of predetermined height sections. The processor 120 may generate voxels respectively corresponding to the classified groups and generate a voxel map including the generated voxels.

The voxel map herein may refer to a map consisting of voxels implemented in a three-dimensional lattice shape of a hexahedron having heights corresponding to the plurality of predetermined height sections, respectively.

The voxel map including the plurality of voxels will be described below in detail.

When the voxel map is generated, the processor 120 may determine height sections of the plurality of voxels, respectively, based on representative values set for the respective plurality of voxels included in the generated voxel map.

According to an embodiment, the processor 120 may generate a section including pieces of 3D data equal to or more than a predetermined threshold number among the plurality of height sections as a voxel.

In addition, the processor 120 may process a section including pieces of 3D data equal to or less than a predetermined threshold number among the plurality of height sections as noise and may not generate a voxel.

Meanwhile, the plurality of height sections may include at least one of a first section for determining that an object is not an obstacle, a second section for determining whether it is able to pass by the object, a third section for avoiding the object, a fourth section in which it is able to pass by a part of the object, and a fifth section in which it is able to pass by the entire object.

Here, the first to fifth sections may be set to heights corresponding to a user command. In addition, the plurality of height sections may be used by being converted into sensing information in different forms depending on the running purpose. Accordingly, the plurality of pieces of obtained 3D data may be used as various types of virtual sensors.

Meanwhile, if it is determined that a representative value of at least one voxel of the plurality of voxels is related to the first section, the processor 120 may perform the control so that the electronic device 100 runs forward.

In addition, if it is determined that the representative value of at least one voxel among the plurality of voxels is related to the remaining sections excluding the first section, the processor 120 may perform the control so that the electronic device 100 runs by avoiding.

Meanwhile, if it is determined that a height of the object that the electronic device has avoided during the running is a threshold height section or lower among the plurality of height sections, the processor 120 may obtain information on the corresponding object from a storage 130 based on 3D data obtained in relation to the corresponding object. Then, the processor 120 may perform the control, after the completion of the running around the corresponding object, to start the running with respect to the corresponding object based on the obtained information on the object.

Herein, the storage 130 may store information on at least one object. Herein, the information on at least one object may include at least one of area information and running possibility information on each object. Accordingly, as described above, the processor 120 may obtain area information on the corresponding object based on the 3D data of the object determined to be in the threshold height section or lower.

Then, the processor 120 may obtain information related to the corresponding area information from the storage 130 by using the obtained area information, and start running with respect to the object determined to be in the threshold height section or lower based on the obtained information.

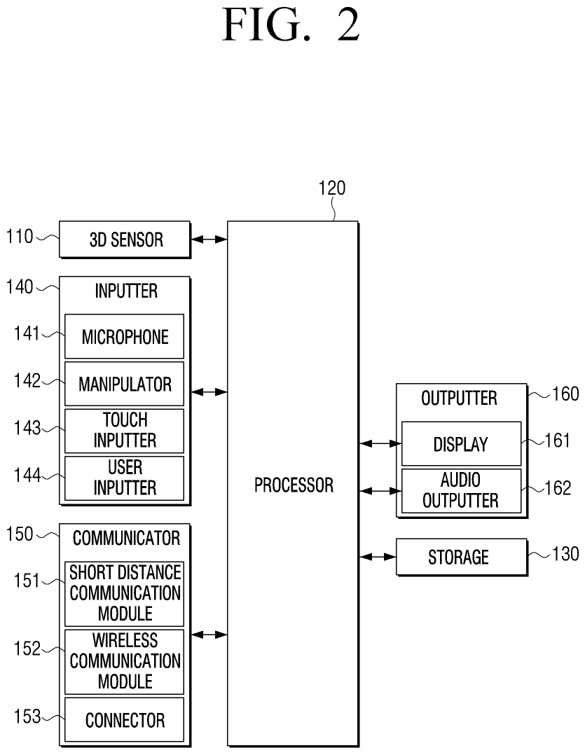

FIG. 2 is a specific block diagram of the electronic device according to an embodiment.

The electronic device 100 according to the disclosure does not only include the 3D sensor 110 and the processor 120 described above, but, referring to FIG. 2, may further include the storage 130, an inputter 140, a communicator 150, and an outputter 160.

As described above, the storage 130 may store information on at least one object. Herein, the information on the object may include at least one of area information on the object and running possibility information on the object.

In addition, the storage 130 may store various operating programs for controlling the operations of the electronic device 100.

The operating program herein may be a program which is read by the storage 130 and compiled to operate the constituent elements of the electronic device 100, when the electronic device 100 is turned on. The storage 130 may be implemented as at least one of a ROM, a RAM, a memory card attachable to and detachable from the electronic device 100 (e.g., an SD card or a memory stick), a non-volatile memory, a volatile memory, a hard disk drive (HDD), or a solid state drive (SSD).

The inputter 140 may receive a user command and transfer the user command to the processor 120.

For this, the inputter 140 may include a microphone 141, a manipulator 142, a touch inputter 143, and a user inputter 144.

The microphone 141 may receive a voice command of the user.

The manipulator 142 may be implemented as a keypad including various functional keys, number keys, special keys, letter keys, and the like.

In addition, if a display 161 which will be described below is implemented as a touch screen, the touch inputter 143 may be implemented as a touch pad forming a layer structure with the display 161. In this case, the touch inputter 143 may receive a selection command for icons related to various applications displayed through the display 161.

The user inputter 144 may receive an IR signal or an RF signal for controlling the operations of the electronic device 100 from a remote control device (not illustrated).

The communicator 150 may perform data communication with a peripheral device (not illustrated) such as a smart TV, a smartphone, and a tablet PC, an external server (not illustrated), and the like.

The communicator 150 may include a short distance communication module 151, a wireless communication module 152 such as a wireless LAN module, and a connector 153 including at least one of wired communication modules such as a high-definition multimedia interface (HDMI), a universal serial bus (USB), and institute of electrical and electronics engineers (IEEE) 1394.

The short distance communication module 151 may be a constituent element configured to perform short distance communication wirelessly with a peripheral device located in short distance from the electronic device 100. The short distance communication module 151 may include at least one of a Bluetooth module, an infrared communication (infrared data association (IrDA)) module, a near field communication (NFC) module, a Wi-Fi module, and a Zigbee module.

The wireless communication module 152 may be a module connected to an external network to perform the communication via a relay device (not illustrated) according to a wireless communication protocol such as IEEE. In addition, the wireless communication module may further include a mobile communication module which accesses a mobile communication network to perform the communication according to various mobile communication standards such as 3rd Generation (3G), 3rd Generation Partnership Project (3GPP), Long Term Evolution (LTE), and the like.

As described above, the communicator 150 may be implemented according to the various short distance communication methods and other communication technologies not mentioned in this specification may be used, as necessary.

Meanwhile, the connector 153 may be a constituent elements providing interfaces with various source devices such as USB 2.0, USB 3.0, HDMI, IEEE 1394, and the like. The connector 153 may receive various pieces of application data from an external server (not illustrated) via a wired cable connected to the connector 153 according to the control command of the processor 120, or receive a power from a power source via a wired cable physically connected to the connector 153.

Meanwhile, when the plurality of pieces of 3D data detected through the 3D sensor 110 are obtained, the processor 120 may control the communicator 150 to transmit the plurality of pieces of obtained 3D data to the external server (not illustrated). Then, the processor 120 may receive voxel map-related information generated based on the plurality of pieces of 3D data from the external server (not illustrated) via the communicator 150.

The outputter 160 may output at least one of image and audio-related data. The outputter 160 may include the display 161 and an audio outputter 162.

The display 161 may display various UI screens for controlling the operation of the electronic device 100 or display information related to the operation state of the electronic device 100.

The display 161 may be implemented as a liquid crystal display (LCD), an organic light emitting display (OLED), and the like.

The audio outputter 162 may output the information related to the operation state of the electronic device 100 as an audible sound.

Meanwhile, the processor 120 may generally control the operations of the electronic device 100 or may be a processing device configured to allow the control of the general operations of the electronic device 100. The processor 120 may be combined with the above constituent elements and implemented as a system-on-a-chip or a system on chip (SOC, SoC).

Hereinabove, the constituent elements of the electronic device 100 according to the disclosure have been described in detail.

Hereinafter, the processor 120 configured to control the autonomous running of the electronic device 100 according to the disclosure will be described in greater detail.

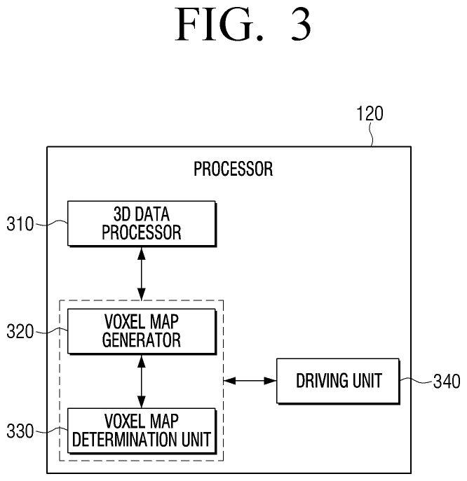

FIG. 3 is a specific block diagram of a processor according to an embodiment.

Referring to FIG. 3, the processor 120 may include a 3D data processor 310, a voxel map generator 320, a voxel map determination unit 330, and a driving unit 340.

The 3D data processor 310 may obtain a plurality of pieces of 3D data based on sensing information detected from the 3D sensor 110. Specifically, the 3D data processor 310 may obtain the plurality of pieces of 3D data respectively including a plurality of 3D coordinate values based on the sensing information detected from the 3D sensor 110.

The voxel map generator 320 may classify the plurality of pieces of 3D data obtained through the 3D data processor 310 into at least one group based on the plurality of predetermined height sections, generate voxels respectively corresponding to the classified groups, and then generate a voxel map including the plurality of generated voxels.

The voxel map generator 320 may generate a section including pieces of 3D data equal to or more than the predetermined threshold number among the plurality of height sections as a voxel, and process a section including the pieces of 3D data less than the predetermined threshold number as noise.

However, the disclosure is not limited thereto, and the voxel map generator 320 may generate the section including the pieces of 3D data exceeding the predetermined threshold number among the plurality of height sections as a voxel, and process a section including the pieces of 3D data equal to or less than the predetermined threshold number as noise.

When the plurality of voxels are generated through the above embodiment, the voxel map generator 320 may generate a voxel map by using the plurality of voxels.

The voxel map determination unit 330 may determine a height section for each of the plurality of voxels based on representative values respectively set for the plurality of voxels included in the voxel map generated through the voxel map generator 320.

Specifically, if it is determined that the representative value of at least one voxel included in the voxel map is related to the first section among the plurality of height sections, the voxel map determination unit 330 may determine that it is able to climb over an object located in front of the electronic device 100.

Meanwhile, if it is determined that the representative value of at least one voxel included in the voxel map is related to the remaining sections excluding the first section among the plurality of height sections, the voxel map determination unit 330 may determine that the object located in front of the electronic device 100 needs to be avoided.

However, the disclosure is not limited thereto, and the voxel map determination unit 330 may set an average value of z values among 3D coordinate values (x, y, z) of the 3D data included in each of the plurality of voxels, as a representative value of each of the plurality of voxels.

For example, the first voxel among the plurality of voxels may include three pieces of 3D data and the z value of each of the three pieces of 3D data may be 1.5, 1.8, and 1.2. In this case, the voxel map determination unit 330 may set an average value, 1.5, of the z values of the three pieces of 3D data included in the first voxel as a representative value of the first voxel.

When the representative values of the plurality of voxels are set through the above example, the voxel map determination unit 330 may, as described above, determine the running direction of the electronic device 100 for running based on the representative values set respectively for the plurality of voxels.

The driving unit 340 may control the running of the electronic device 100 based on the determination result of the voxel map determination unit 330.

As described above, if it is determined that it is able to climb over the object located in front of the electronic device 100 through the voxel map determination unit 330, the driving unit 340 may perform the control so as to run by climbing over the object located in front of the electronic device 100.

According to the control command of the driving unit 340, the electronic device 100 may run by climbing over the object located in front thereof.

Meanwhile, if it is determined that the object located in front of the electronic device 100 needs to be avoided through the voxel map determination unit 330, the driving unit 340 may perform the control so as to run by avoiding the object located in front of the electronic device 100.

According to the control command of the driving unit 340, the electronic device 100 may run by changing the direction to a right or left direction with respect to the object located in front thereof.

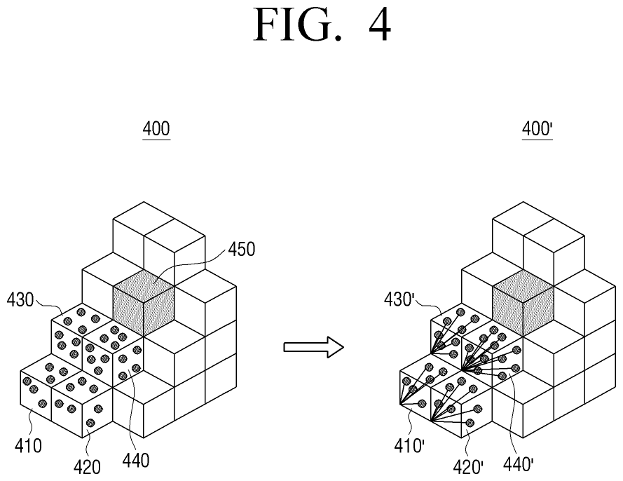

FIG. 4 is a diagram of an example in which a voxel map is generated according to an embodiment.

Referring to FIG. 4, when the plurality of pieces of 3D data are obtained based on the sensing information sensed through the 3D sensor 110, the electronic device 100 may classify the plurality of pieces of obtained 3D data into at least one group based on the plurality of predetermined height sections.

Then, the electronic device 100 may generate voxels respectively corresponding to the classified groups and generate a voxel map 400 including the generated voxels.

Herein, the voxel map may be a map consisting of voxels implemented in a three-dimensional lattice shape of a hexahedron having heights corresponding to the plurality of predetermined height sections, respectively.

In other words, each voxel may have a height corresponding to each of the plurality of predetermined height sections. Accordingly, the electronic device 100 may group at least one piece of 3D data included in the first height section and a first width section among the plurality of pieces of 3D data as a first voxel 410 based on a 3D coordinate value included in each of the plurality of pieces of 3D data.

In addition, the electronic device 100 may group at least one piece of 3D data included in the first height section and a second width section among the plurality of pieces of 3D data as a second voxel 420 based on a 3D coordinate value included in each of the plurality of pieces of the 3D data.

Herein, the first height section may be a section in which the electronic device 100 runs by climbing over the object in front in the direction in which the electronic device 100 runs.

Meanwhile, the electronic device 100 may group at least one piece of 3D data included in the second height section and the first width section among the plurality of pieces of 3D data as a third voxel 430 based on a 3D coordinate value included in each of the plurality of pieces of 3D data.

In addition, the electronic device 100 may group at least one piece of 3D data included in the second height section and the second width section among the plurality of pieces of 3D data as a fourth voxel 440 based on a 3D coordinate value included in each of the plurality of pieces of 3D data.

Herein, the second height section may be a section in which the electronic device 100 runs by avoiding the object in front in the direction in which the electronic device 100 runs.

Meanwhile, if the number of at least one piece of 3D data classified into one voxel group among the plurality of pieces of 3D data is equal to or less than the predetermined threshold number, the electronic device 100 may process the at least one piece of 3D data classified into the corresponding voxel group as noise.

Referring to the drawing, a fifth voxel 450 formed with the third height section and the second width section may include the pieces of 3D data equal to or less than the predetermined threshold number. In this case, the electronic device 100 may process the 3D data included in the fifth voxel 450 as noise.

When the voxel map 400 including the plurality of voxels is generated through the above embodiment, the electronic device 100 may set a 3D coordinate value of the 3D data included in each of the plurality of voxels included in the voxel map 400 as a representative value set for each of the plurality of voxels.

Referring to FIG. 4, the electronic device 100 may set a 3D coordinate value of each of the plurality of pieces of 3D data included in a first voxel 410′ among the plurality of voxels included in a voxel map 400′ as a first representative value set for the first voxel 410′.

In addition, the electronic device 100 may set a 3D coordinate value of each of the plurality of pieces of 3D data included in a second voxel 420′ among the plurality of voxels included in the voxel map 400′ as a second representative value set for the second voxel 420′.

Further, the electronic device 100 may set a 3D coordinate value of each of the plurality of pieces of 3D data included in a third voxel 430′ among the plurality of voxels included in the voxel map 400′ as a third representative value set for the third voxel 430′.

Moreover, the electronic device 100 may set a 3D coordinate value of each of the plurality of pieces of 3D data included in a fourth voxel 440′ among the plurality of voxels included in the voxel map 400′ as a fourth representative value set for the fourth voxel 440′.

As described above, the electronic device 100 may set the 3D coordinate value of each the plurality of pieces of 3D data included in the plurality of voxels as the representative value set for each voxel to optimize an amount of data thereof.

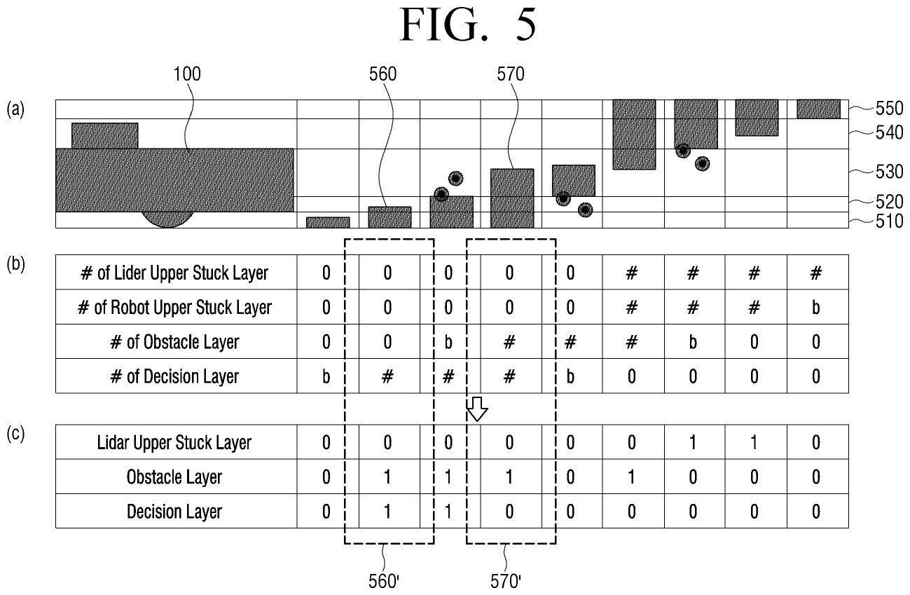

FIG. 5 is a diagram of an example in which a voxel map is determined on the electronic device according to an embodiment.

Part (a) of FIG. 5 illustrates heights of objects located in a direction in which the electronic device 100 runs based on the generated voxel map, and part (b) of

FIG. 5 is a voxel table showing presence of the object in each section based on the plurality of voxels included in the generated voxel map.

Specifically, referring to part (a) of FIG. 5, a first section 510 is a section in which it is able to climb over the object located in the direction in which the electronic device 100 runs and may not be included in the voxel table of part (b) of FIG. 5.

A second section 520 may be a section for determining whether it is able to climb over the object located in the direction in which the electronic device 100 runs, and if the object is detected in the second section 520 from the voxel map, this may be displayed in a box of a decision layer of the voxel table in part (b) of FIG. 5.

A third section 530 may be a section for avoiding the object located in the direction in which the electronic device 100 runs, and if the object is detected in the third section 530 from the voxel map, this may be displayed in a box of an obstacle layer of the voxel table in part (b) of FIG. 5.

A fourth section 540 may be a section in which the object is present in the direction in which the electronic device 100 runs but a remaining part of the electronic device 100 excluding the 3D sensor 110 attached to an upper surface of the electronic device 100 is able to pass by the object, and this may be displayed in a box of a robot upper stuck layer of the voxel table in part (b) of FIG. 5.

A fifth section 550 may be a section in which the object is present in the direction in which the electronic device 100 runs but the electronic device 100 is able to pass by the object, and this may be displayed in a box of a Lidar upper stuck layer of the voxel table in part (b) of FIG. 5.

Meanwhile, part (c) of FIG. 5 is a final running table for determining the running of the electronic device 100 based on the voxel table illustrated in part (b) of FIG. 5, and may be a map excluding the robot upper stuck layer of the voxel table in part (b) of FIG. 5.

Specifically, if it is determined that a representative value 560 of the first voxel among the plurality of voxels included in the voxel map is included in the second section 520, the electronic device 100 may display “#” in the box of the decision layer corresponding to the second section 520 in the voxel table included in a dashed line box 560′.

Meanwhile, the second section 520 may be a section in which the electronic device 100 is able to perform both the climbing and the avoiding. For example, a rug and a remote control may have heights included in the second section 520. Accordingly, if the object is the rug, the electronic device 100 needs to run by climbing over the rug, and if the object is the remote control, the electronic device 100 may run by avoiding the remote control.

Accordingly, if “#” is displayed in the box of the decision layer corresponding to the second section 520 in the voxel table included in the dashed line box 560′, the electronic device 100 may display “1” in each of the box of the decision layer corresponding to the second section 520 and the box of the obstacle layer corresponding to the third section 530 in the final running table included in the dashed line box 560′.

As described above, if “1” is displayed in each of the box of the decision layer and the box of the obstacle layer of the final running table included in the dashed line box 560′, the electronic device 100 may run by determining whether to climb over or avoid the object related to the first voxel.

Meanwhile, if it is determined that a representative value 570 of the second voxel among the plurality of voxels included in the voxel map is included in the third section 530, the electronic device 100 may display “#” in the box of the decision layer and the box of the obstacle layer respectively corresponding to the second and third sections 520 and 530 in the voxel table included in a dashed line box 570′.

Then, the electronic device 100 may display “1” in the box of the obstacle layer of the final running table included in the dashed line box 570′ based on “#” displayed in each of the box of the decision layer and the box of the obstacle layer of the voxel table included in the dashed line box 570′.

As described above, if “1” is displayed in the box of the obstacle layer of the final running table included in the dashed line box 570′, the electronic device 100 may run by avoiding the object related to the second voxel.

Meanwhile, “b” displayed in the voxel table of part (b) of FIG. 5 is a section where the voxel including the pieces of 3D data equal to or less than the predetermined threshold number is positioned. Accordingly, the electronic device 100 may display, in the final running table, “0” indicating that the object is not present in a section corresponding to the section where the voxel displayed with “b” is positioned.

Accordingly, the electronic device 100 may perform the running by avoiding or climbing over the object located in the running direction based on the final running table created through the above embodiment.

Meanwhile, as described above, if “1” is displayed in the box of the decision layer corresponding to the second section 520 and the box of the obstacle layer corresponding to the third section 530 in the final running table in relation to the first voxel, the electronic device 100 may run by determining whether to climb over or avoid object related to the first voxel through the above embodiment.

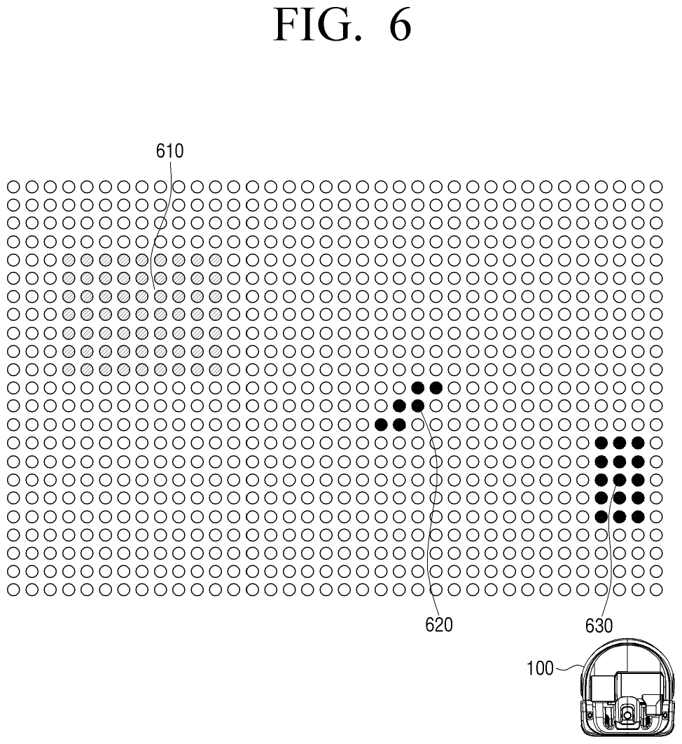

FIG. 6 is a diagram of an example in which it is determined whether to run by an object on the electronic device according to an embodiment.

Referring to FIG. 6, the electronic device 100 may clean while autonomously running the inside of a building excluding first to third regions 610 to 630 based on the final running table described above.

The first to third regions 610 to 630 herein may be regions where the objects are located. In addition, the object located in the first region 610 among the first to third regions 610 to 630 has a height included in the second section 520 described with reference to FIG. 5. The objects located in the second and third regions 620 and 630 have heights included in the third section 530 described with reference to FIG. 5.

In this case, when the cleaning is completed by autonomously running the remaining region excluding the first to third regions 610 to 630 where the objects are located, the electronic device 100 may determine whether it is able to climb over the object located in the first region 610 among the first to third regions 610 to 630.

Specifically, the electronic device 100 may measure an area of the object located in the first region 610 by using the representative value of each voxel representing the object located in the first region 610. Then, the electronic device 100 may determine the object located in the first region 610 by comparing area information included in pre-stored information on the at least one object to the measured area of the object located in the first region 610.

As a result of the determination, if it is determined that the object located in the first region 610 is an object such as a rug that the electronic device is able to climb over, the electronic device 100 may run by climbing over the object located in the first region 610.

Hereinabove, the constituent elements and the operations of the electronic device 100 performing the running according to the object located in the surrounding area according to the disclosure have been described in detail. Hereinafter, a method for performing the running according to the object located in the surrounding area on the electronic device 100 according to the disclosure will be described in detail.

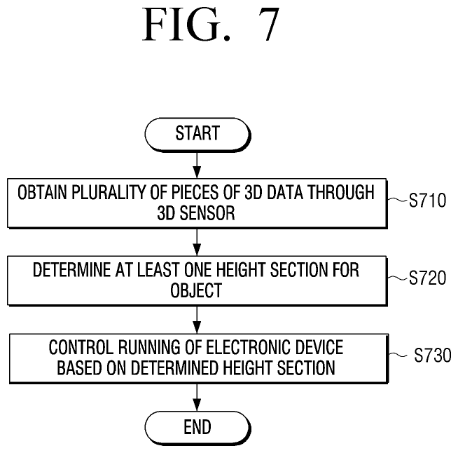

FIG. 7 is a flowchart of a method for controlling the electronic device according to an embodiment.

Referring to FIG. 7, the electronic device 100 may obtain a plurality of pieces of 3D data through the 3D sensor provided in the electronic device 100 while the electronic device 100 runs (S710).

According to an embodiment, the 3D sensor may be a 3D Lidar sensor which recognizes the surrounding environment three-dimensionally to allow the electronic device 100 such as a vehicle or a robot cleaner to autonomously run safely. The 3D Lidar sensor may measure a distance by continuously emitting several millions of laser beams per second and measuring a period of time taken for the several millions of the emitted laser beams being reflected and returning to the 3D Lidar sensor.

When the plurality of pieces of 3D data are obtained based on the information sensed through the 3D sensor, the electronic device 100 may determine at least one section for the object present in the direction in which the electronic device 100 runs among the plurality of predetermined height sections by using the plurality of pieces of obtained 3D data (S720).

Then, the electronic device 100 may control the running of the electronic device 100 based on the determined height section of the object (S730).

Hereinafter, a method for determining at least one height section for the object present in the direction in which the electronic device 100 runs by using the plurality of pieces of 3D data on the electronic device 100 will be described in detail.

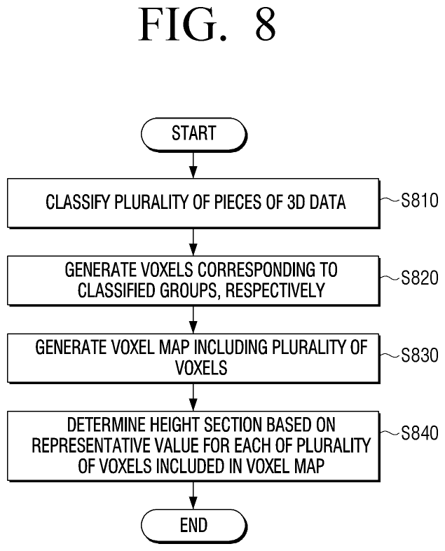

FIG. 8 is a flowchart of a method for determining a height section of an object present in a running direction of the electronic device by using a plurality of pieces of 3D data on the electronic device according to an embodiment.

Referring to FIG. 8, the electronic device 100 may classify the plurality of pieces of obtained 3D data into at least one group based on the plurality of predetermined height sections (S810). Then, the electronic device 100 may generate voxels corresponding to the classified groups, respectively (S820).

When the voxels corresponding to the classified groups respectively are generated, the electronic device 100 may generate a voxel map including the plurality of generated voxels (S830).

The voxel map herein may refer to a map consisting of voxels implemented in a three-dimensional lattice shape of a hexahedron having heights corresponding to the plurality of predetermined height sections, respectively.

Then, the electronic device 100 may determine a height section of each of the plurality of voxels based on the representative value set for each of the plurality of voxels included in the voxel map (S 840).

According to an embodiment, the electronic device 100 may generate the section including the pieces of 3D data equal to or more than the predetermined threshold number among the plurality of height sections as the voxel. In addition, the electronic device 100 may process a section including the pieces of 3D data equal to or less than the predetermined threshold number among the plurality of height sections as noise and may not generate a voxel.

Meanwhile, the plurality of height sections may include at least one of a first section for determining that an object is not an obstacle, a second section for determining whether it is able to pass by the object, a third section for avoiding the object, a fourth section in which it is able to pass by a part of the object, and a fifth section in which it is able to pass by the entire object.

Accordingly, if it is determined that the representative value of at least one voxel among the plurality of voxels is related to the first section in the step 5840 described above, the electronic device 100 may perform the control so that the electronic device 100 runs forward.

In addition, if it is determined that the representative value of at least one voxel among the plurality of voxels is related to the remaining sections excluding the first section, the electronic device 100 may perform the control so that the electronic device 100 runs by avoiding.

Further, if it is determined that the height of the object avoided during the running in the step 5730 described above is the threshold height section or lower among the plurality of height sections described above, the electronic device 100 may obtain information on the corresponding object from the storage based on the 3D data obtained in relation to the corresponding object. Then, the electronic device 100 may perform the control, after the completion of the running around the corresponding object, to start the running with respect to the corresponding object based on the obtained information on the object.

Various embodiments of the disclosure may be implemented as software including instructions stored in machine (e.g., computer)-readable storage media. The machine is an apparatus which invokes instructions stored in the storage medium and is operated according to the invoked instructions, and may include an electronic device (e.g., electronic device 100) according to the disclosed embodiments. In a case where the instruction is executed by a processor, the processor may perform a function corresponding to the instruction directly or using other elements under the control of the processor. The instruction may include a code made by a compiler or a code executable by an interpreter. The machine-readable storage medium may be provided in a form of a non-transitory storage medium. Here, the “non-transitory” storage medium is tangible and may not include signals, and it does not distinguish that data is semi-permanently or temporarily stored in the storage medium.

According to an embodiment, the methods according to various embodiments disclosed in this disclosure may be provided in a computer program product. The computer program product may be exchanged between a seller and a purchaser as a commercially available product. The computer program product may be distributed in the form of a machine-readable storage medium (e.g., compact disc read only memory (CD-ROM)) or distributed online through an application store (e.g., PlayStore™). In a case of the on-line distribution, at least a part of the computer program product may be at least temporarily stored or temporarily generated in a storage medium such as a memory of a server of a manufacturer, a server of an application store, or a relay server.

Each of the elements (e.g., a module or a program) according to various embodiments described above may include a single entity or a plurality of entities, and some sub-elements of the abovementioned sub-elements may be omitted or other sub-elements may be further included in various embodiments. Alternatively or additionally, some elements (e.g., modules or programs) may be integrated into one entity to perform the same or similar functions performed by each respective element prior to the integration. Operations performed by a module, a program, or other elements, in accordance with various embodiments, may be performed sequentially, in a parallel, repetitive, or heuristically manner, or at least some operations may be performed in a different order, omitted, or may add a different operation.

What is claimed is:

1. A method for controlling an electronic device, the method comprising:
obtaining a plurality of pieces of 3D data based on sensing information detected through a 3D sensor while the electronic device runs;
determining at least one height section of an object present in a direction in which the electronic device runs among a plurality of predetermined height sections by using the plurality of pieces of obtained 3D data; and
controlling running of the electronic device based on the determined height section of the object.

2. The method according to claim 1, wherein the determining comprises:
classifying the plurality of pieces of 3D data into at least one group based on the plurality of height sections;
generating voxels corresponding to the classified groups, respectively; and
generating a voxel map including the generated voxels.

3. The method according to claim 2, wherein the determining further comprises determining a height section of each of the plurality of voxels based on a representative value set for each of the plurality of voxels included in the voxel map.

4. The method according to claim 2, wherein the generating the voxel map comprises generating a section including the pieces of 3D data equal to or more than a predetermined threshold number among the plurality of height sections as a voxel.

5. The method according to claim 2, wherein the generating the voxel map comprises not generating a voxel by processing a section including the pieces of 3D data equal to or less than a predetermined threshold number among the plurality of height sections as noise.

6. The method according to claim 1, wherein the controlling comprises:
based on a height of the object being determined in a threshold height section or lower among the plurality of height sections, obtaining information on the object based on the 3D data; and
after the running around the object is completed, performing control to start running with respect to the object based on the information on the object.

7. An electronic device comprising:
a 3D sensor; and
a processor configured to:
based on a plurality of pieces of 3D data being obtained through the 3D sensor while the electronic device runs, determine at least one height section of an object present in a direction in which the electronic device runs among a plurality of predetermined height sections by using the plurality of pieces of obtained 3D data, and control running of the electronic device based on the determined height section of the object.

8. The device according to claim 7, wherein the processor is configured to:
classify the plurality of pieces of 3D data into at least one group based on the plurality of height sections;
generate voxels corresponding to the classified groups, respectively; and
generate a voxel map including the generated voxels.

9. The device according to claim 8, wherein the processor is configured to determine a height section of each of the plurality of voxels based on a representative value set for each of the plurality of voxels included in the voxel map.

10. The device according to claim 8, wherein the processor is configured to generate a section including the pieces of 3D data equal to or more than a predetermined threshold number among the plurality of height sections as a voxel.

11. The device according to claim 8, wherein the processor is configured to not generate a voxel by processing a section including the pieces of 3D data equal to or less than a predetermined threshold number among the plurality of height sections as noise.

12. The device according to claim 8, wherein the plurality of height sections comprises at least one of:
a first section for determining that an object is not an obstacle;
a second section for determining whether it is able to pass by the object;
a third section for avoiding the object;
a fourth section in which it is able to pass by a part of the object; and
a fifth section in which it is able to pass by the entire object.

13. The device according to claim 12, wherein the processor is configured to:
based on a representative value of at least one voxel among the plurality of voxels being determined to be related to the first section, perform control so that the electronic device runs forward; and
based on a representative value of at least one voxel among the plurality of voxels being determined to be related to the remaining sections excluding the first section, perform control so that the electronic device avoids the object.

14. The device according to claim 7, further comprising:
a storage storing information on at least one object,
wherein the processor is configured to:
based on a height of the object being determined in a threshold height section or lower among the plurality of height sections, obtain information on the object from the storage based on the 3D data, and
after the running around the object is completed, perform control to start running with respect to the object based on the information on the object.

15. The device according to claim 7, wherein the 3D sensor is a 3D light detection and ranging (LIDAR) sensor.
